(19) United States
(12) Patent Application Publication
(10) Pub. No.: US 2019/0068089 A1
(43) Pub. Date: Feb. 28, 2019

(54) MOTOR DRIVE CONTROL DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Hitoshi SAITO, Yokohama Kanagawa (JP)

(21) Appl. No.: 15/908,824

(22) Filed: Mar. 1, 2018

(30) Foreign Application Priority Data
Aug. 28, 2017 (JP) 2017-163706

(51) Int. Cl. H02P 5/74; B64D 27/24; B64D 31/12; B64D 45/00; B64C 27/08

(52) U.S. Cl. CPC H02P 5/74; B64D 27/24; B64D 31/12; B64C 39/024; B64C 27/08; B64D 2045/0085; B64D 45/00

(57) ABSTRACT

A motor drive control device includes a main controller that generates a PWM control signal for instructing a rotational speed of a motor. The motor drive control device includes a signal switch that converts the PWM control signal supplied from the main controller into differential data, and outputs the differential data to two transmission lines. An electric speed controller is connected to the two transmission lines, and receives the differential data and responds to the differential data to supply a drive signal to the motor.

### CROSS-REFERENCE TO RELATED APPLICATIONS

This application is based upon and claims the benefit of priority from Japanese Patent Application No. 2017-163706, filed Aug. 28, 2017, the entire contents of which are incorporated herein by reference.

### FIELD

Embodiments described herein relate generally to a motor drive control device.

### BACKGROUND

In the related art, a technique is disclosed in which a PWM (Pulse Width Modulation) control signal is supplied from a main controller to an electric speed controller (ESC) to control a motor that drives each rotor of a multicopter.

However, the PWM control signal is an analog signal, which is easily affected by disturbance of noise. In the multicopter, the flight speed and the flight attitude are determined by propulsion generated by rotation of rotors that are driven by the motor. For this reason, it is desirable to accurately supply the control signal to the ESC from the main controller. In addition, the multicopter includes, for example, four or six motors and the same number of rotors as the number of the motors. The multicopter flies with these multiple motors and rotors. If abnormality occurs in any motor, it is desirable that information on the occurred abnormality is timely supplied to the main controller and a control command that reflects the abnormality information is supplied to the ESC from the main controller.

### DESCRIPTION OF THE DRAWINGS

FIG. 1 is a view illustrating a configuration of a motor drive control device according to a first embodiment;

FIG. 2 illustrates a waveform of a CAN signal;

FIG. 3 is a view illustrating a configuration of an ESC;

FIG. 4 is a view illustrating a configuration of a motor drive control device according to a second embodiment;

FIG. 5 illustrates a waveform of an RS485 signal; and

FIG. 6 is a view illustrating a configuration of a motor drive control device according to a third embodiment.

### DETAILED DESCRIPTION

Embodiments provide a motor drive control device capable of supplying information indicating an operation state of a motor to a main controller and accurately supplying a control command from the main controller to an ESC.

According to one embodiment, a motor drive control device includes a main controller that generates a PWM control signal for instructing a rotational speed of a motor. The motor drive control device includes a signal switch that converts the PWM control signal supplied from the main controller into differential data, and outputs the differential data to two transmission lines. An electric speed controller is connected to the two transmission lines, and receives the differential data and responds to the differential data to supply a drive signal to the motor.

Hereinafter, a motor drive control device according to embodiments will be described in detail with reference to the drawings. Incidentally, the present disclosure is not limited by the embodiments.

### First Embodiment

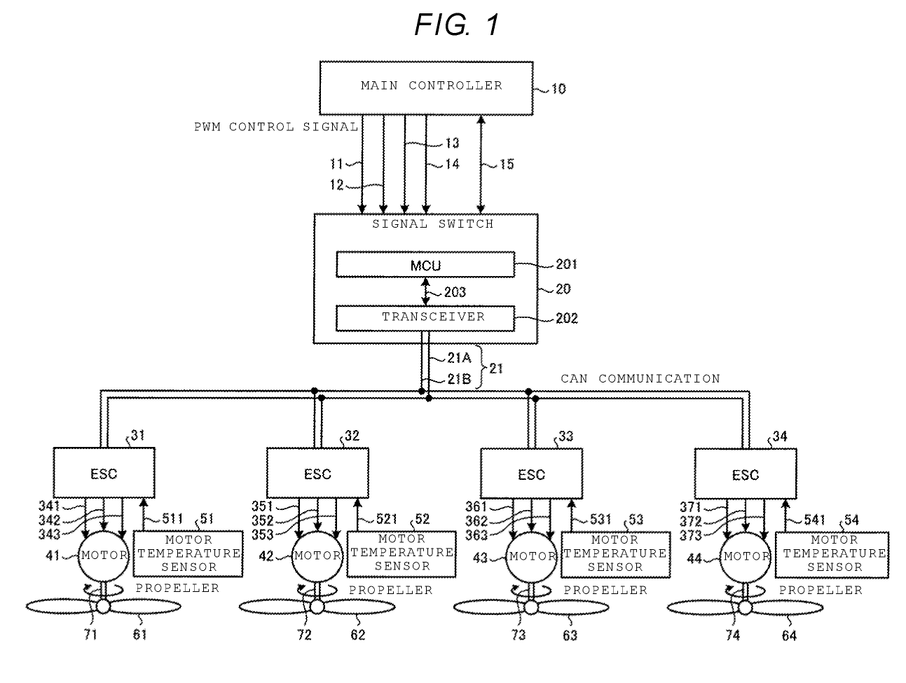

FIG. 1 is a view illustrating a configuration of a motor drive control device of a first embodiment. The motor drive control device of this embodiment includes a main controller 10. The main controller 10 generates PWM control signals for specifying the rotational speeds of motors 41 to 44, which are drive control targets. The PWM control signals corresponding to the motors 41 to 44 are supplied through signal lines 11 to 14 to a signal switch 20.

The signal switch 20 converts the PWM control signal supplied from the main controller 10 into a digital signal of CAN (Controller Area Network) specifications (hereinafter, referred to as a CAN signal in some cases). The digital signal of CAN specifications has logic levels “0” and “1” which are associated with a differential voltage between two bus signal transmission lines. The digital signal of CAN specifications is associated with the differential voltage, and thus is called differential data. The signal switch 20 converts the PWM control signal supplied from the main controller 10 into a digital signal according to the pulse width thereof and sends out the digital signal as the digital signal of CAN specifications.

For example, the signal switch 20 includes an MCU (Micro Controller Unit) 201 which converts the PWM control signal into a digital signal, and a transceiver 202 which converts the digital signal output by the MCU 201 into the digital signal of CAN specifications. The signal between the MCU 201 and the transceiver 202 is transferred through the signal line 203. The digital signal of CAN specifications will be described later.

The transfer of the data between the main controller 10 and the signal switch 20 is performed through the signal line 15. The transfer of the data which is performed through the signal line 15 conforms to, for example, telecommunications standard RS232C (Recommended Standard 232C) (hereinafter, referred to as the RS232C). The RS232C is a physical layer interface specification of unbalanced serial transfer. A predetermined process which performs conversion to the signal based on the RS232C is performed by, for example, the main controller 10 and the MCU 201 provided in a signal switch 20. The information indicating the operation state of the motors 41 to 44 as drive control targets is supplied through the signal switch 20 to the main controller 10. When the information from the motors 41 to 44 is supplied to the main controller 10, the control command that is issued according to the operation state of the motors 41 to 44 can be supplied from the main controller 10 to the ESCs 31 to 34.

The CAN signal from the signal switch 20 is supplied to the ESCs 31 to 34 through a CAN communication transmission path 21 having the bus signal lines 21A and 21B. For example, the bus signal line 21A corresponds to a bus line CANH, and the bus signal line 21B corresponds to a bus line CANL. The respective addresses corresponding to the ESCs 31 to 34 are applied as identification signals to the CAN signals supplied from the signal switch 20 so as to specify an ESC of the ESCs 31 to 34.

Each ESC 31 to 34 (drive unit) generates a drive signal in response to a control signal from the signal switch 20 to supply the drive signal through the signal lines (341 to 343, 351 to 353, 361 to 363, and 371 to 373) to the motors 41 to 44, respectively. For example, the motors 41 to 44 are three-phase induction motors, and from the signal lines 341 to 343, 351 to 353, 361 to 363, and 371 to 373), three-phase (U-phase, V-phase, and W-phase) signals are supplied to exciting coils (not illustrated) of the motors 41 to 44.

The motors 41 to 44 rotate rotating shafts (71 to 74) in response to the supplied drive signal, thereby rotating propellers 61 to 64. The lifting power is generated by the rotation of the propellers 61 to 64 to lift, for example, a multicopter (not illustrated) mounted with the motor drive control device of this embodiment.

In the ESCs 31 to 34, the data from the motor temperature sensors 51 to 54, which measure the temperatures of the motors 41 to 44 is supplied through the signal lines 511, 521, 531, and 541. For example, the ESCs 31 to 34 control the drive signal supplied to the corresponding motors 41 to 44 based on the data supplied from motor temperature sensors 51 to 54 to adjust the rotational speed of the motors. For example, by the control to stop supplying the driving current to a motor that is in an abnormal high-temperature state, motor damage from overheating can be avoided.

The data from the motor temperature sensors 51 to 54 are supplied to the main controller 10 through the ESCs 31 to 34 and the signal switch 20. With such a configuration, the main controller 10 can be configured to generate a control signal to control the rotational speed of the motors 41 to 44 while considering the temperature information of the motors 41 to 44. The data of the motor temperature sensors 51 to 54 may be configured to be supplied to the main controller 10 usually at a predetermined timing, and may be configured to be supplied to the main controller 10 as an abnormal signal in a case where the temperature of the motor exceeds a predetermined threshold.

In this embodiment, the signal switch 20 converts the PWM control signal generated by the main controller 10 into the CAN signal, so as to supply the CAN signal to the ESCs 31 to 34. The PWM control signal as an analog signal is converted into a digital signal of CAN specifications to send to the ESCs 31 to 34, with improved noise immunity. The speed instruction command output by the main controller 10, can have improved immunity against environmental noise during transfer to the ESCs 31 to 34. Accordingly, the instruction command of the rotational speed of the motor can be supplied accurately to motor driving units (hereinafter, the component including the ESCs 31 to 34 is referred to as motor driving units in some cases) including the ESCs 31 to 34.

The information indicating the operation state of the motor, for example, the temperature information of the motor is supplied to the main controller 10 through the signal switch 20. With such a configuration, the control signal reflecting the operation state of the motor can be generated by the main controller 10 to be supplied to the ESCs 31 to 34, so as to perform a fine driving control according to the operation state of the motor.

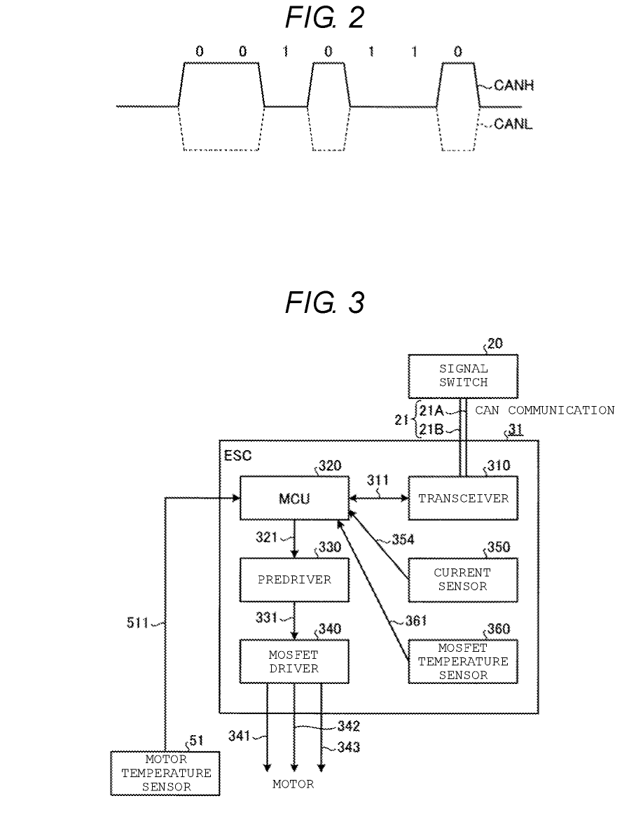

FIG. 2 illustrates a waveform of the CAN signal. The CAN data is configured with the differential data supplied to the two bus lines CANH and CANL. In a case where a voltage difference (the voltage of the CANH−the voltage of the CANL) supplied to the bus line CANH indicated by a solid line and the bus line CANL indicated by a dotted line is smaller than, for example, a predetermined voltage, the logic level is set to “1”, and in a case where the voltage difference is larger than the predetermined voltage, the logic level is set to “0.”

The PWM control signal sent from the main controller 10 is converted by the signal switch 20 into the CAN signal based on the CAN specifications, and is sent out to the CAN communication transmission path 21. The CAN signal is the differential data supplied between the two bus lines CANH and CANL. For this reason, for example, even in a case where a noise is overlapped with the voltage of the bus lines CANH and CANL, the noise is mutually cancelled between the two bus lines CANH and CANL. Thus, the signal becomes excellent in the noise resistance, and the command signal from the main controller 10 is supplied accurately to the motor driving unit.

FIG. 3 is a view illustrating one configuration example of the ESC. The description will be given by using the ESC 31 as an example. The ESC 31 has a transceiver 310. The transceiver 310 performs a predetermined process on the CAN signal supplied from the signal switch 20 through the CAN communication transmission path 21, and supplies the CAN signal through a signal line 311 to an MCU 320. The transceiver 310 converts, for example, the CAN signal into a format which the MCU 320 can process and supplies the CAN signal to the MCU 320. In addition, conversely, the transceiver 310 converts the signal sent from the MCU 320 into the CAN signal and sends out the CAN signal to the CAN communication transmission path 21.

The MCU 320 supplies the drive signal of the motor through the signal line 321 to a predriver 330. The drive signal of the motor is amplified by the predriver 330 and is supplied through the signal line 331 to a gate of a MOSFET (not illustrated) configuring a MOSFET driver 340. The on/off of the MOSFET configuring the MOSFET driver 340 is controlled such that, for example, the MOSFET driver 340 generates a three-phase drive signal and supplies the signal through the signal line 341 to 343 to the motor.

The ESC 31 has a current sensor 350. The current sensor 350 detects, for example, currents which flow in the MOSFET configuring the MOSFET driver 340, and supplies the information through the signal line 354 to the MCU 320. The current value can be obtained from the voltage drop generated in resistances (not illustrated) connected in the MOSFET in series and the value of the resistance.

The ESC 31 has a MOSFET temperature sensor 360. The MOSFET temperature sensor 360 detects, for example, the temperature of the MOSFET configuring the MOSFET driver 340, and supplies the information through the signal line 361 to the MCU 320.

The operation state of the motor can be perceived when the information, which indicates the operation state of the motor by using the current information supplied from the current sensor 350 or the temperature information supplied from the MOSFET temperature sensor 360, is supplied to the MCU 320. That is, the operation state of the motor is perceived so that the drive signal which is supplied from the MCU 320 to the predriver 330 can be adjusted according to the state thereof. For example, by limiting the current supplied to the MOSFET when the MOSFET driver 340 becomes overheated, it is possible to avoid the damage of the MOSFET which results from the overheating.

The MCU 320 can be configured such that the information of the motor temperature sensor 51 is supplied thereto. The temperature information of the motor is supplied to the MCU 320, and the drive signal which is supplied through the predriver 330 can be adjusted according to the information. For example, by limiting the current supply to the MOSFET driver 340 which drives the motor in a case where the motor is in an abnormal overheat state, it is possible to avoid the damage of the motor which results from the abnormal overheating.

When the ESC 31 is configured with the transceiver 310 which can convert the operation information of the motor into the CAN signal and send out the signal to the CAN communication transmission path 21, the ESC 31 can communicate with the main controller 10 in a bidirectional manner. That is, the control signal from the main controller 10 is converted by the signal switch 20 into the CAN signal and is supplied to the ESC 31, and the information supplied from the ESC 31 is converted by the transceiver 310 into the CAN signal and is supplied through the signal switch 20 to the main controller 10. Accordingly, the main controller 10 can perform the control according to the operation state of the motor as a drive control target.

In addition, the bidirectional transfer of accurate information can be performed by transmitting/receiving the information which is transmitted/received between the main controller 10 and the ESCs 31 to 34 as the CAN data configured with the CAN signal has excellent noise resistance. The information of the operation states of the motors 31 to 34 can be accurately obtained from the ESCs 31 to 34, and further, the control command which is based on the information and is sent from the main controller 10 with respect to the rotational speed of the motors 41 to 44 can be supplied to the ESCs 31 to 34.

### Second Embodiment

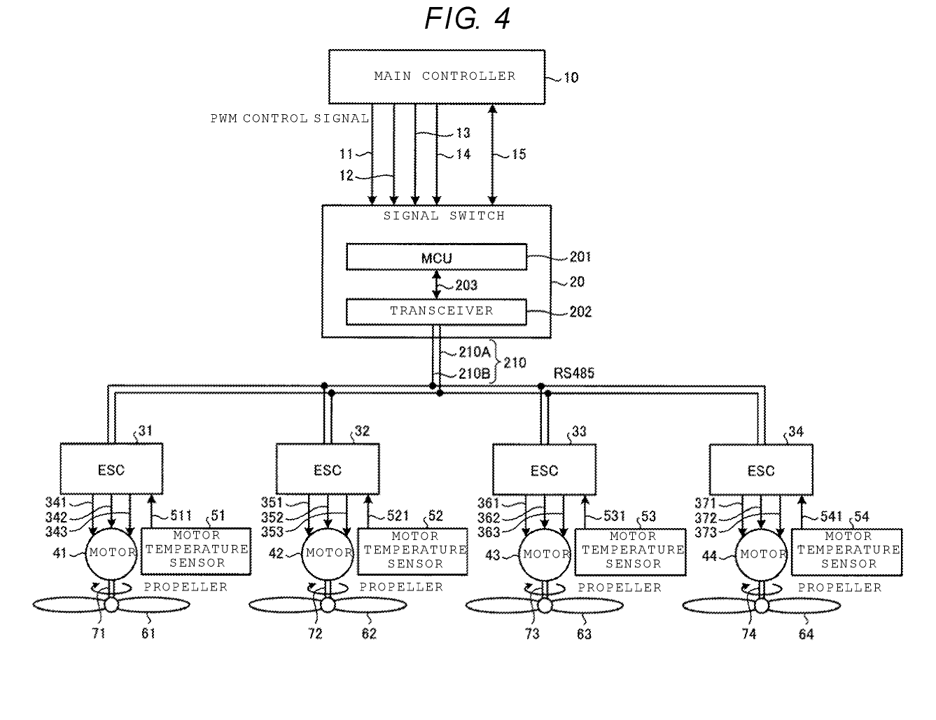

FIG. 4 is a view illustrating a configuration of a motor drive control device of a second embodiment. The same reference numerals are denoted by the same components which correspond to the configuration of the above-described embodiment, and the redundant explanation will be given only as needed. In the motor drive control device of this embodiment, the signal switch 20 converts the PWM control signal sent from the main controller 10 into the differential data based on telecommunications standard RS485 (Recommended Standard 485, and hereinafter, referred to as the RS485) and outputs the differential data. The RS485 is a serial interface standard, and the data is transmitted by differential pair.

For example, the signal switch 20 includes the MCU 201 which converts the PWM control signal into a digital signal and a transceiver 202 which converts the digital signal output by the MCU 201 into a digital signal of RS485 specifications based on the RS485.

The output signal of the signal switch 20 is supplied through an RS485 transmission path 210 to the ESCs 31 to 34. The RS485 transmission path 210 includes a non-inverted transmission line 210A and an inverted transmission line 210B. The differential data supplied through the RS485 transmission path 210 is converted by the transceivers (not illustrated) included by the ESCs 31 to 34, and supplied to the MCUs (not illustrated) included by the ESCs 31 to 34.

Similarly to the CAN signal, the data which is transmitted/received through the RS485 transmission path 210 is differential data. For this reason, the control command sent from the main controller 10 can be supplied to the ESCs 31 to 34 in a condition of excellent noise resistance. Accordingly, the rotational speed of the motors 41 to 44 can be accurately controlled by the main controller 10.

This embodiment has the signal switch 20, which converts the PWM control signal of the main controller 10. In a case where the ESCs 31 to 34, which supply the drive signal to the motors 41 to 44 as drive control targets have the RS485 specifications, the PWM control signal sent from the main controller 10 can be converted by the signal switch 20 into the differential data based on the RS485, and can be supplied to the ESCs 31 to 34. By converting the PWM control signal of the main controller 10 into a digital signal (hereinafter, referred to as an RS485 signal in some cases) based on the RS485, the control command of the main controller 10 can be supplied to the ESCs 31 to 34 during the condition of excellent noise resistance.

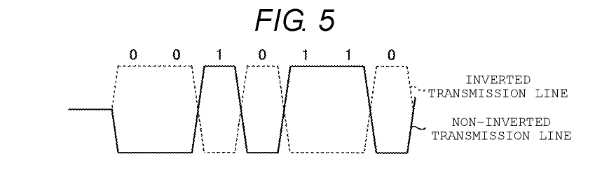

FIG. 5 illustrates a waveform of the RS485 signal. The RS485 data is configured with the differential data which is supplied by the non-inverted transmission line and the inverted transmission line. In the case of transmitting the logic level “1”, a high voltage level is applied to the non-inverted transmission line indicated by the solid line, and a low voltage level is applied to the inverted transmission line indicated by the dotted line. Conversely, in the case of transmitting the logic level “0”, the high voltage level is applied to the inverted transmission line, and the low voltage level is applied to the non-inverted transmission line. Accordingly, the differential data is configured which is associated with the voltage difference between two transmission lines.

The PWM control signal output from the main controller 10 is converted by the signal switch 20 to the differential data based on the RS485 specification, and is sent out to the RS485 transmission path 210. The data based on the RS485 is the differential data supplied between the non-inverted transmission line and the inverted transmission line. For this reason, for example, even in a case where a noise is overlapped with the voltage of the non-inverted transmission line and the inverted transmission line, the noise is mutually cancelled between the non-inverted transmission line and the inverted transmission line. Thus, the signal acquires excellent noise resistance. When the PWM control signal sent from the main controller 10 is converted into the RS485 signal and is supplied to the ESCs 31 to 34, the control command sent from the main controller 10 is accurately supplied to the motor driving unit.

### Third Embodiment

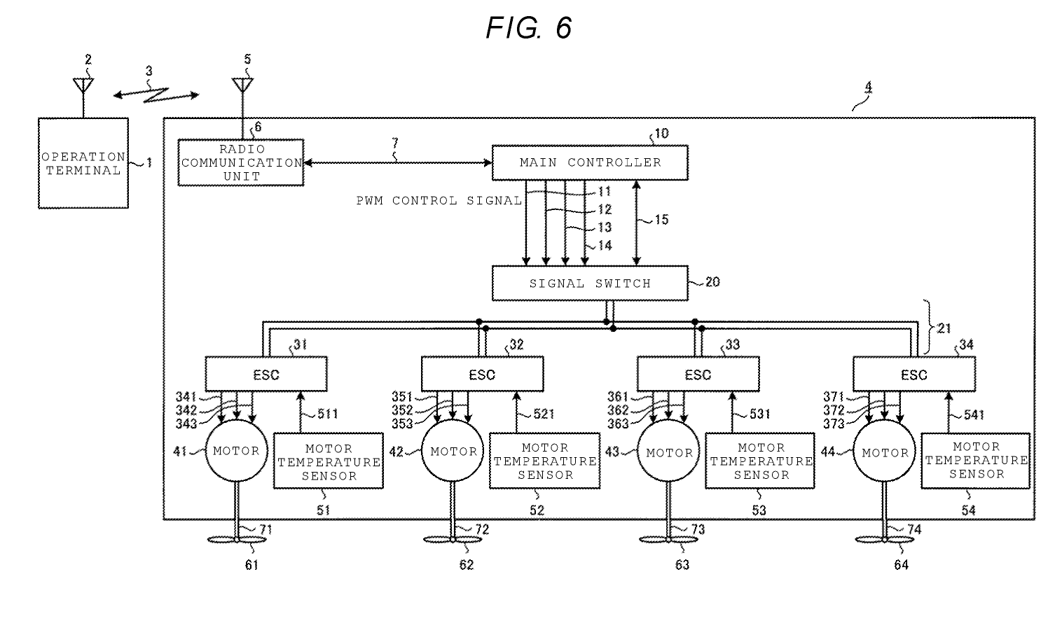

FIG. 6 is a view illustrating a configuration of a motor drive control device of a third embodiment. This embodiment has an operation terminal 1. The operation terminal 1 is operated by an operator. An operation signal sent from the operation terminal 1 is supplied as a radio signal 3 through an antenna 2 to an antenna 5 provided in a moving object 4.

The moving object 4 is, for example, an unmanned multicopter which is generally called a drone. The radio signal 3 which is received by the antenna 5 is supplied to a radio communication unit 6. The radio communication unit 6 converts the radio signal 3 received by the antenna 5 into, for example, a control signal of a digital signal and supplies the control signal through the signal line 7 to the main controller 10.

The main controller 10 supplies, for example, the signal indicating the operation state of the motors 41 to 44 through the signal line 7 to the radio communication unit 6. The radio communication unit 6 converts the signal sent from the main controller 10 into the radio signal 3 and transmits the radio signal through the antenna 5 to the antenna 2 of the operation terminal 1. Accordingly, the operation terminal 1 and the moving object 4 can communicate with each other in a bidirectional manner.

The moving object 4 is mounted with, for example, the above-described motor drive control device of the first embodiment. That is, the moving object 4 includes the main controller 10, the signal switch 20 which converts the PWM control signal generated by the main controller 10 into the CAN signal and supplies the CAN signal to the CAN communication transmission path 21, and the ESCs 31 to 34 to which the CAN signal sent from the signal switch 20 is supplied.

In this embodiment, the PWM control signal of the main controller 10 is converted by the signal switch 20 into the CAN signal, and is supplied to the ESCs 31 to 34 which control the rotation number of the motors 41 to 44. By such a configuration that the PWM control signal of the main controller 10 is converted into the CAN signal with excellent noise resistance and is supplied to the ESCs 31 to 34, the control command of the main controller 10 can be accurately supplied to the ESCs 31 to 34.

The main controller 10 and the ESCs 31 to 34 can communicate with each other through the CAN communication transmission path 21 in a bidirectional manner. For this reason, the main controller 10 can perform the control according to the operation state of the motors 41 to 44.

When the information on the operation state of the motors 41 to 44 is transmitted from the main controller 10 through a radio line including the radio communication unit 6 to the operation terminal 1, the operator can rule the operation state of the motors 41 to 44. Accordingly, the operator can rule the flight state of the moving object 4 to perform the operation of the operation terminal 1.

Incidentally, the disclosure is not limited by the embodiment in which the propellers 61 to 64 are driven by the motors 41 to 44. For example, the moving object 4 may be a so called radio-controlled car or a two-wheeled vehicle in which a wheel (not illustrated) is driven by the motors 41 to 44, or vehicles such as a ship and a robot which are driven by units other than a wheel. The travel is controlled by supplying the PWM control signal, which instructs the rotational speed supplied from the main controller 10, through the signal switch 20 to the ESCs 31 to 34, so as to control the rotational speed of the motors 41 to 44.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A motor drive control device comprising:
a main controller that generates a PWM (Pulse Width Modulation) control signal for instructing a rotational speed of a motor;
a signal switch that converts the PWM control signal supplied from the main controller into differential data, and outputs the differential data to two transmission lines; and
an electric speed controller connected to the two transmission lines, and that receives the differential data and responds to the differential data to supply a drive signal to the motor.

2. The motor drive control device according to claim 1, wherein
the differential data are generated according to Controller Area Network bus specifications.

3. The motor drive control device according to claim 1, wherein
the differential data are generated according to the telecommunication standard RS485.

4. The motor drive control device according to claim 2, wherein
the electric speed controller converts data indicating an operation state of the motor into a motor digital signal and supplies the motor digital signal to the signal switch, and
the signal switch performs a predetermined process on the motor digital signal and supplies the processed motor digital signal to the main controller.

5. The motor drive control device according to claim 4, wherein the data indicating the operation state of the motor is temperature data of the motor.

6. The motor drive control device according to claim 4, wherein the data indicating the operation state of the motor is current data of the motor.

7. The motor drive control device according to claim 4, wherein the differential data are generated according to Controller Area Network bus specifications.

8. The motor drive control device according to claim 4, wherein the motor digital signal supplied to the signal switch is generated according to the telecommunication standard RS485.

9. A multicopter comprising:
a body;
propellers, each of which is rotated by a motor to generate lift for the body; and
a motor drive control device comprising:
a main controller that generates a PWM (Pulse Width Modulation) control signal for instructing a rotational speed of a motor;
a radio communication unit that supplies a control signal to the main controller through radio communication;
a signal switch that converts the PWM control signal supplied from the main controller into differential data, and outputs the differential data into two transmission lines; and
an electric speed controller connected to the two transmission lines that receives the differential data and responds to the differential data by supplying a drive signal to the motor.

10. The motor drive control device according to claim 9, wherein the differential data are generated according to Controller Area Network bus specifications.

11. The motor drive control device according to claim 9, wherein the differential data are generated according to the telecommunication standard RS485.

12. The motor drive control device according to claim 10, wherein
the electric speed controller converts data indicating an operation state of the motor into a motor digital signal and supplies the motor digital signal to the signal switch, and
the signal switch performs a predetermined process on the motor digital signal and supplies the processed motor digital signal to the main controller.

13. The motor drive control device according to claim 12, wherein the data indicating the operation state of the motor is temperature data of the motor.

14. The motor drive control device according to claim 12, wherein the data indicating the operation state of the motor is current data of the motor.

15. A method for communication between a main controller and a multicopter having at least one motor controlled by an electric speed controller that receives signals over a two wire transmission line, comprising:
generating a PWM (Pulse Width Modulation) control signal for instructing a rotational speed of a motor at a main controller;
converting the PWM control signal into differential data, and outputting the differential data into two transmission lines; and
receiving the differential data at the electric speed controller, wherein the electric speed controller responds to the differential data by supplying a drive signal to the motor.

16. The method according to claim 15, wherein the differential data are outputted as two different voltage levels between the two transmission lines such that a maximum voltage difference is a logical 0.

17. The method according to claim 15, wherein
the differential data are generated according to the telecommunication standard RS485.

18. The method according to claim 15, wherein
the electric speed controller converts data indicating an operation state of the motor into a motor digital signal and supplies the motor digital signal as differential data to the two transmission lines.

19. The method according to claim 18, wherein the data indicating the operation state of the motor is temperature data of the motor.

20. The method according to claim 19, wherein a radio communication unit supplies a control signal to the main controller through radio communication.
